(19) United States
(12) Patent Application Publication
(10) Pub. No.: US 2007/0217283 A1
(43) Pub. Date: Sep. 20, 2007

(54) Paint stirrer system

(76) Inventor: David Eaton, Mcall, ID (US)

Correspondence Address: DYKAS, SHAVER & NIPPER, LLP, P.O. BOX 877, BOISE, ID, 83701-0877, US

(21) Appl. No.: 11/384,203

(22) Filed: Mar. 16, 2006

(51) Int. Cl. B01F 13/00

(52) U.S. Cl. 366/129

(57) ABSTRACT

A paint mixing system made up of a generally firm elongated stirrer with a first end that extends along a generally symmetrical straight body length to a second end, and a sleeve. The stirrer is generally configured for insertion within the sleeve, and when put together the sleeve and the stirrer are configured to interact so as to allow for the mixing of paint by moving the device within the can of paint. After the mixing of paint to a desired consistency, the stirrer sleeve can be removed and replaced.

### FIELD OF THE INVENTION

The invention generally relates to paint mixing, and more particularly to a method and device for mixing paint prior to the application of paint upon a surface.

### BACKGROUND OF THE INVENTION

From the beginning of time man has sought ways to enhance the environment in which he lives. One of the ways in which this is done is that man has sought ways to decorate or vary the color or appearance of various items. One of the ways in which this is done is through the use of paints. Paints are generally mixtures of various items that are suspended in a base or liquid that can be mixed so that their application upon a surface imparts the desired characteristics to the surface.

It is well known in the art that when paints are made in a generally centralized location and then shipped to another location, the items within the paint have a tendency to settle. As these items settle, various solutes fall out of suspension and collect in the bottom portion of the container. This is particularly true in situations where paint is shipped from a production location to various warehouse locations and ultimately to a store shelf. Upon the store shelf, paint that is to be sold in containers of cans is placed in a position, wherein the top of the can is upward and the bottom of the can is downward. In this position paint has a tendency to settle.

Prior to the application of this paint, it must be mixed in order to allow for the proper coverage and characteristics to me imparted upon the surface to which the paint is applied. There exists a variety of ways of having this take place.

One way is for the can to be shaken so as to attempt to suspend the paint particles within the paint and achieve the paint mixture having the desired viscosity and consistency. In other embodiments, paint is mixed by inserting various items into the paint and then moving these items within the paint so as to disturb the settled material. This causes the material to rise from its settled position and to be mixed within the solution. However, in such an embodiment the devices that are inserted into the paint container will typically end up covered in paint and altered in such a way so as to reduce their usefulness in further applications, or use in other mixtures where addition of other paints and colors is no longer desired.

The present invention therefore, provides a novel device for allowing the reuse of mixing devices and particularly mixing sticks. This reduces the cost involved in distributing items that are typically only useable once and typically increases the life of these items. This translates to a reduction in the consumption of natural resources as well as a reduction in the quantity and quality of matter that is discarded at the end of a painting activity.

Additional objects, advantages and novel features of the invention will be set forth in part in the description that follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The present invention is a paint mixing system made up of a generally firm elongated stirrer with a first end that extends along a generally symmetrical straight body length to a second end. The first end of the stirrer is generally adapted to be grasped, and the second end of the device is adapted for insertion into a disposable sleeve. This disposable sleeve has an open first end and extends along a generally hollow body to a closed second end.

The stirrer is generally configured for insertion within the sleeve, and when put together the sleeve and the stirrer are configured to interact so as to allow for the mixing of paint by moving the device into the can of paint to be mixed.

In one embodiment of the invention, this takes place by providing a system for mixing paint, said system including a generally firm elongated stirrer that has a first end and extends along a generally symmetrical straight body to a second end. The first end being generally adapted to be grasped. The second end of the stirrer is adapted for insertion within a disposable sleeve. The disposable sleeve has an open first end and extends along a generally hollow body to a closed second end. The stirrer is inserted within the sleeve. The sleeve and the stirrer are inserted within a can of paint to be mixed. The paint within the can is then mixed by moving and rotating the stirrer. When the paint has been sufficiently mixed, the stirrer can be removed and the sleeve, which is positioned over the stirrer, can be discarded. In further applications the sleeve can be replaced over the same stirrer.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention, which is measured by the claims, nor is it intended to be limiting as to the scope of the invention in any way.

Still other features and advantages of the present invention will become readily apparent to those skilled in this art from the following detailed description describing only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows a first end view of first preferred embodiment of the invention.

FIGS. 2 and 4 are side elevation views of the present invention shown in FIG. 1.

FIGS. 3 and 5 are front and rear views of the embodiment of the invention shown in FIG. 1.

FIG. 6 shows a second end view of the first preferred embodiment of the invention.

FIG. 7 shows a side view of the present invention shown in FIG. 1.

FIG. 8 shows the side view shown in FIG. 7, with the slip cover portion of the device having been partially removed.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

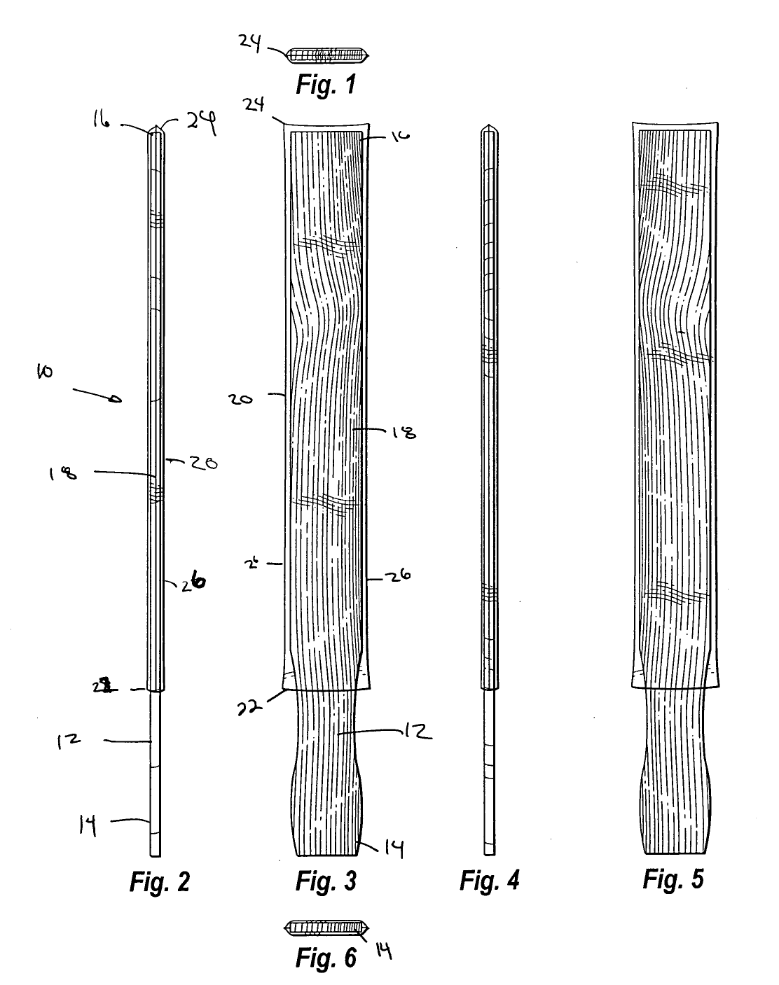

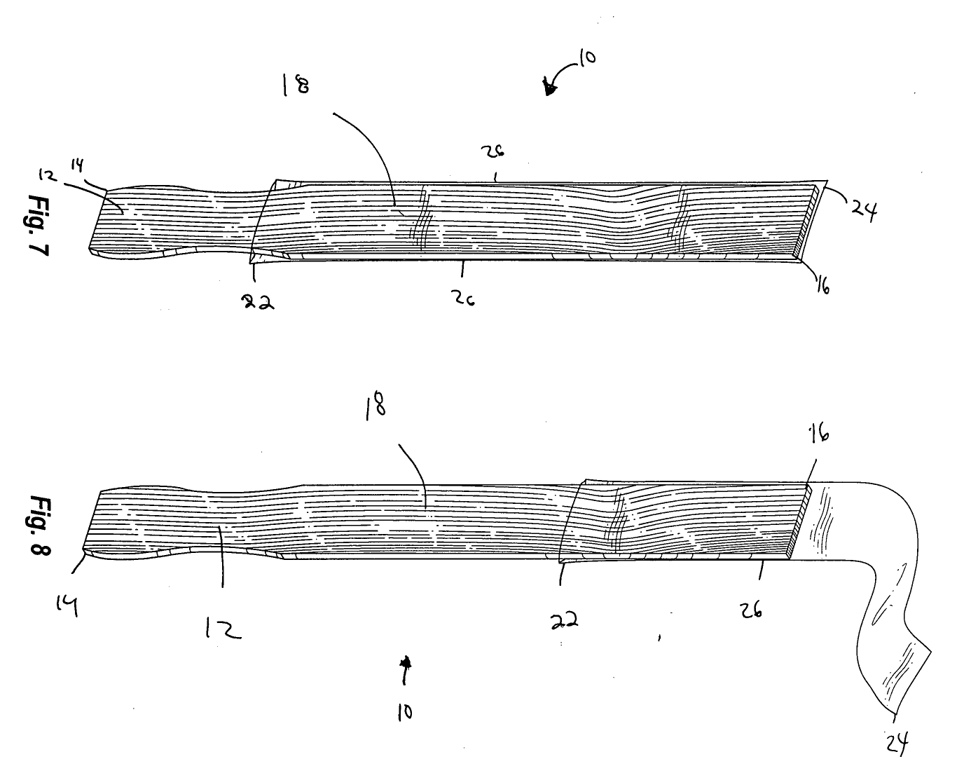

The present invention 10 is a system for mixing paint and a method for mixing this paint. As is shown in FIGS. 1-8, a variety of views of the present invention are shown. As is shown in these figures, the present invention is a system for mixing paint with reduced waste that presently exists. The device of the invention is comprised of a generally firm elongated paint stirrer 12 that is configured for insertion within a sleeve 20. The sleeve 20 and stirrer 12 can then be used together and inserted into a can of paint to mix the paint until a desired viscosity is achieved. Once this desired consistency and viscosity has been achieved, the system may be removed from the paint bucket and the sleeve 20, which has been connected to the paint stirrer 12. Depending upon the number of cans or uses that may be required, additional sleeves 20 may then be placed over the stirrer 12, and this process is repeated until a desired and preselected number of paint cans have been stirred. This invention provides a new and novel way to prevent the use of additional stirrers, which can be expensive, by replacing sleeves that cover the stirrers rather than by replacing the stirrers themselves.

Referring now to FIGS. 1-8, a variety of views of the present invention are shown. The system of the present invention is made up of a stirrer 12, which is generally straight and made from a generally rigid or firm material. Typical materials that the stirrer 12 can be made from include wood, plastic, metal or other suitable materials. The stirrer 12 of the invention has a first end 14 and extends along a generally straight body 18 to a second end 16. In some embodiments of the invention, the first end 14 is configured to be grasped and held within the hand of a user. The second end 16 of the stirrer 12 is configured to be placed within a sleeve 20 which will be described in more detail hereafter. In some embodiments of the invention, the stirrer 12 may have various forms of advertising placed upon it.

The stirrer 12 is configured for placement within a sleeve 20. This sleeve 20 is preferably made from a flexible material such as plastic or latex, which is formed by sealing the edges 26 of a strip of such material so as to define a generally hollow body. When these edges 26 are sealed, a sleeve 20 is formed. This sleeve 20 has an open first end 22, and a closed second end 24. Preferably, the length of this strip is sufficient so as to allow the sides of the sleeve 20 to extend up to the graspable portion of the first end 14 of the stirrer 12, and is wide enough so as to allow the stirrer itself to be inserted within the sleeve 20 in such a way whereby the quantity of excess material is reduced. This configuration allows a user to be able to grasp and hold the sleeve over the stirrer while stirring the paint. In other embodiments of the invention, a variety of methods for maintaining the sleeve 20 around the stirrer may also be employed.

For purposes of illustration, in one preferred embodiment of the invention the stirrers 12 have a length of about 12″, a width of about 1″, and thickness of about 0.15″. The sleeve 20 is then configured to be placed over this device. This sleeve 20 has dimensions of approximately a length of 12″ and a width of 1.25″. While these particular dimensions are provided herein, it is to be distinctly understood that the invention is not limited thereto, but may be variously embodied to meet the necessities of a user. In particular, it is to be distinctly understood that the system of the present invention may be appropriately modified to cover stirrers of any desired size.

The device is utilized by inserting the stirrer 12 into the sleeve 20. This is done by placing the second end 16 of the stirrer 12 within the open end 22 of the sleeve 20 and pushing this stirrer 12 down into the sleeve 20 until the closed second end 24 of the sleeve 20 is in contact with the second end 16 of the stirrer 12. Once this positioning of the stirrer 12 within the sleeve 20 has taken place, the combination of the stirrer 12 and the sleeve 20 can then be rotated, or otherwise moved about within the paint so as to enable the paint within the can to be mixed to a desired consistency. After this mixing has taken place, the sleeve 20, which is now covered with paint, may be removed and discarded. In subsequent mixing operations, a new sleeve can simply be placed over the stirrer 12 so as to allow the same stirrer 12 to be used repeatedly without contamination of paint and without having to obtain a new stirrer each time.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A paint mixing system comprising:
a generally firm elongated stirrer having a first end and extending along a generally symmetrical straight body to a second end, said first end generally adapted to be grasped, said second end adapted for insertion within a disposable sleeve;
said disposable sleeve having an open first end and extending along a generally hollow body to a closed second end.

2. The paint mixing system of claim 1, wherein said disposable sleeve is configured to extend between said first and second ends of said elongated stirrer.

3. The paint mixing system of claim 1, wherein said sleeve is made from a plastic material.

4. The paint mixing system of claim 1, wherein said sleeve is interchangeable with a variety of other similarly configured sleeves.

5. The paint mixing system of claim 1, wherein said sleeve is made from a latex material.

6. The paint mixing system of claim 1, wherein said stirrer has a length of 12″, a width of 1″ and thickness of 0.15″.

7. The paint mixing device of claim 6, wherein said sleeve has a length of 12″ and a width of 1.25″.

8. A disposable paint stirrer cover comprising:
a generally straight elongated sleeve having an open first end and extending along a closed body to a closed second end, said sleeve defining a cavity adapted to receive a paint stirrer therein.

9. The paint stirrer cover of claim 8, wherein said disposable paint stirrer cover contains pairs of edges that are sealed together.

10. The paint stirrer cover of claim 9, wherein said sleeve is dimensioned to extend between said first and second ends of a paint stirrer.

11. The paint stirrer cover of claim 9, wherein said sleeve is plastic.

12. The paint stirrer cover of claim 9, wherein said sleeve is made from latex.

13. A method for mixing paint comprising the steps of:
providing a system for mixing paint, said system comprising a generally firm elongated stirrer having a first end and extending along a generally symmetrical straight body to a second end, said first end generally adapted to be grasped, said second end adapted for insertion within a disposable sleeve; said disposable sleeve having an open first end and extending along a generally hollow body to a closed second end;
inserting said stirrer within said sleeve;
inserting said system within a can of paint to be mixed;
manually mixing said paint by moving said system within said can of paint;
removing said system from said can of paint when said paint has been sufficiently mixed;
removing said sleeve from said stirrer; and
discarding said sleeve.

14. The method of claim 13 further comprising the step of replacing said sleeve with a new sleeve.

15. The method of claim 13, wherein said sleeve is a plastic sleeve with sealed edges.

16. The method of claim 13, wherein said sleeve is a latex sleeve with sealed edges.

17. The method of claim 13, wherein said sleeve extends the entire length of said stirrer.
